(19) United States
(12) Patent Application Publication
(10) Pub. No.: US 2004/0154474 A1
(43) Pub. Date: Aug. 12, 2004

(54) Food cooker

(76) Inventor: Alex Chan, Kowloon (CN)

Correspondence Address: ALIX YALE & RISTAS LLP, 750 MAIN STREET, SUITE 1400, HARTFORD, CT, 06103, US

(21) Appl. No.: 10/755,562

(22) Filed: Jan. 12, 2004

(30) Foreign Application Priority Data
Jan. 10, 2003 (GB) 0300589.9

(51) Int. Cl. A47J 37/12

(52) U.S. Cl. 99/407; 99/413

(57) ABSTRACT

A food cooker, in particular a deep fryer, comprises a vessel in which a cooking medium is heated and a basket for supporting food to be cooked The basket is adapted to move between a first position in which the food is immersed in the cooking medium and a second position in which the food is emersed from the cooking medium. Apparatus is provided for vibrating the basket in the second position to assist in removing excess cooking medium from the food.

### BACKGROUND OF THE INVENTION

1. Field of the Invention

The invention relates to food cookers, and in particular to deep fryers for use with a quantity of oil for cooking food.

2. Background Information

Cooking food by immersing it in a hot cooking medium, such as cooking oil or fat, is well-known. Apparatus used in this process are commonly referred to as deep fryers, or deep fat fryers. A typical deep fryer comprises a vessel in which the cooking medium is heated. A perforated basket is provided for supporting food to be cooked. The basket is placed in the vessel to immerse the food in the hot cooking medium. When cooking is finished the basket is lifted to remove the food from the cooking medium.

During the cooking process the food becomes saturated with the cooking medium and so the basket is suspended above the cooking medium for a period of time in order to permit excess cooking medium on the food to drain and fall back into the vessel.

Because the cooking medium can reach high temperatures, cooking in this way is fast. However, the need to drain the cooked food increases the cooking time. Furthermore because of an increasingly health conscious society it is desirable to remove as much of the cooking medium from the food as possible before eating.

### SUMMARY OF THE INVENTION

It is an object of the present invention to provide a immersion-type food cooker with an improved method of removing excess cooking medium from cooked food, which improves on the draining time of prior art cookers, or which at least provides the public with a useful alternative.

According to a first aspect of the invention there is provided a food cooker comprising:

a chamber in which a cooking medium is heated;

a basket for supporting food to be cooked and movable between a first position in which the food is immersed in the cooking medium and a second position in which the food is emersed from the cooking medium, and

means for vibrating the basket for a predetermined length of time when it is in the second position.

According to a second aspect of the invention there is provided a deep fryer, for use with a quantity of oil for cooking food, comprising:

a container for receiving and heating a quantity of oil,

a basket for holding food items and movable between a cooking position in which the food is immersed in the oil and a draining position in which the food is emersed from the oil, and

means for vibrating the basket in the draining position.

According to a third aspect of the invention there is provided a deep fryer, for use with a quantity of oil for cooking food, comprising

a housing defining a chamber for receiving and heating a quantity of oil,

a basket for holding food items within the chamber, and movable between an immersed position and an emersed position,

a support for the basket and for selectively moving the basket between the immersed position and the emersed position, and

a vibrator for vibrating the support or basket in the emersed position.

Preferably, the vibrator is a motor positioned with the support or basket and driving an offset unbalanced weight

Preferably, the support is slidably positioned with the housing, and the vibrator includes a motor for driving a cam and a linkage between the cam and support for moving the support forward and backward.

Preferably, the deep fryer further includes a switch for activating the vibrator, and a timer for deactivating the vibrator after a predetermined length of time.

Preferably, the switch activates the motor when the basket is moved to the emersed position.

Preferably, the predetermined length of time is 30 to 60 seconds.

Preferably, the support includes a handle.

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 illustrates a first embodiment of a food cooker according to the invention,

FIGS. 2 and 3 illustrate a second embodiment of a food cooker according to the invention,

FIG. 4 illustrates the cooker of FIG. 2 with the cooking basket in the cooking, or immersed, position,

FIG. 5 illustrates the cooker of FIG. 2 with the cooking basket in the draining, or emersed, position, and

FIG. 6 illustrates the vibrating mechanism of the cooker of FIG. 2.

### DETAILED DESCRIPTION OF THE PREFERRED EMBODIMENT

In the drawings like reference numerals represent like elements.

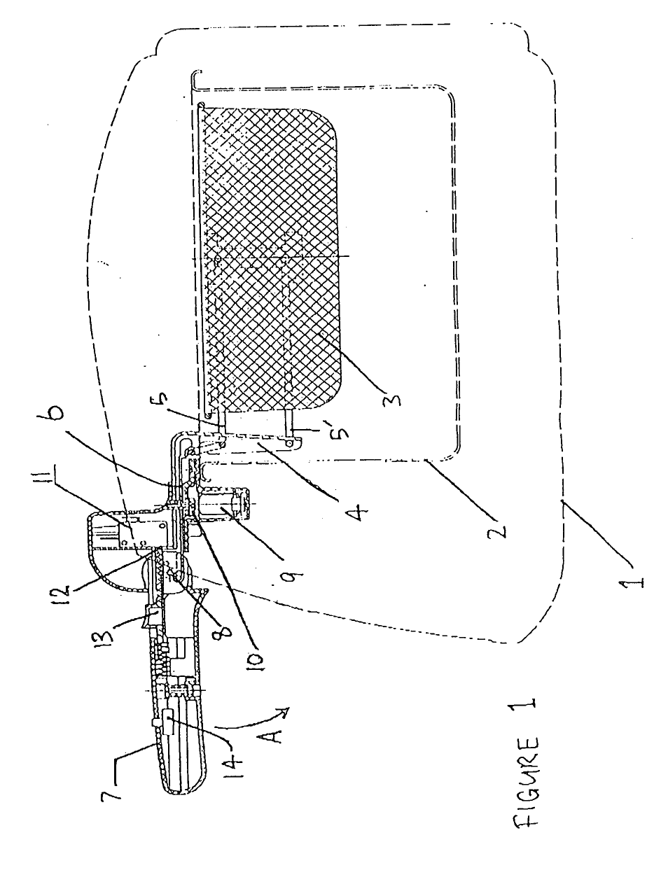

Referring to FIG. 1, in a first particular embodiment of the invention an immersion-type cooker, such as a deep fryer, comprises a housing 1 which defines a chamber, or container 2 for receiving a quantity of cooking medium, such as oil or fat. Below or in association with the container 2 is a heating element (not shown) for heating and maintaining the temperature of the oil. A perforated mesh basket 3 is provided for supporting food to be cooked. The basket 3 can be moved between a first draining position in which it occupies an upper portion of the container 2 (as shown in FIG. 1) and a cooking or immersed position in which it occupies a lower portion of the container 2. The container 2 is filled with an appropriate quantity of oil so that in the draining position the basket, and food, are emersed from the oil and in the cooking position the food is immersed in the cooking oil.

A support 4 with arms 5 is provided for holding the basket 3. A handle 7 is mounted on a pivot 8 and connected to support 4 by a linkage 6. With the handle 7 in an upper horizontal position (as shown in FIG. 1) the basket is in the draining position. When the handle 7 is moved to a lower position by pivoting in the direction of arrow A the basket is moved to the lower cooking position.

A DC motor 9 is mounted on the support 4 and is provided with an offset unbalanced weight 10 on its output shaft. A micro-switch 11 with contact button 12 is mounted proximate the handle 7. When the handle 7 is in the upper position (as shown in FIG. 1) a handle knob 13 engages micro-switch button 12 closing the micro-switch. A switch 14 on handle 7 is operated by a user to activate the motor 9. The motor 9 is interlocked by micro-switch 11 so that it can only be activated via switch 14 when the handle 7 is in the upper position.

Activation of the motor 9 causes the support 4 and basket 3 to vibrate due to the effect of the offset unbalanced weight 10. The vibration shakes excess oil or fat from the cooked food.

In one embodiment of the invention a timer 23 is provided which is activated with the motor 9 and causes the motor 9 to turn off after a predetermined length of time. The preferred length of time is 30 to 60 seconds.

In use, food is placed in the basket 3 and handle 7 is moved to the lower position to immerse the food in pro-heating cooking oil. After the required cooking time handle 7 is moved to the upper position emersing the food from the oil. Micro-switch 11 is activated by knob 13 and switch 14 is operated to activate vibrating DC motor 9. The timer 23 is also activated. After the timer 23 reaches the predetermined time of between 30 and 60 seconds it de-activates the motor 9. In this way, a user need not monitor the vibration period after the motor 9 is activated.

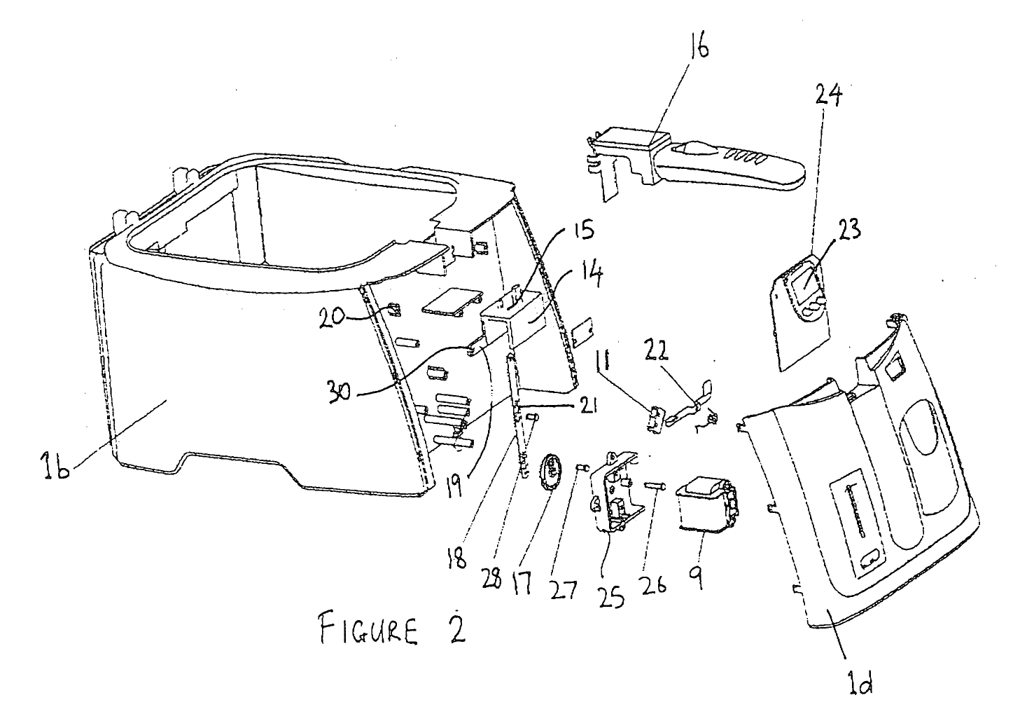

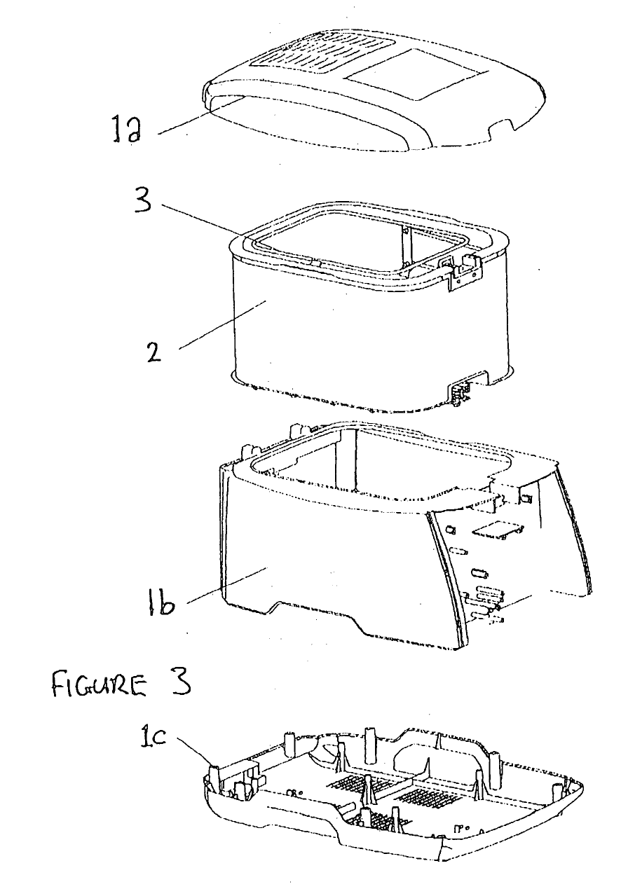

Referring to FIGS. 2, 3 and 5, in a second particular embodiment of the invention, the support 14 is slidably mounted on housing 2. An upper surface 15 of support 14 is adapted to receive the handle 16. The motor 9 is mounted to housing 1 via a mounting bracket 25. A driving gear 29 is located on output shaft 26 of motor 9 and drives a cam wheel 17. A rod 18 is pivotally mounted to housing 1 by its first end at a pivot point 20. The second end of the rod 15 is engaged with cam wheel 17 at an eccentric pivot 27. A tab 19 of support 14 has a pin 30 that movably engages with a centrally located elongate slot 21 in rod 18. In use, motor 10 drives cam wheel 17 which causes rod 18 to move to and fro in a pendulum motion about pivot 20. Rod 18 in turn moves support 14 alternately via tab 19 backward and forward. Handle 16 is engaged with support surface 15 and engages basket 3. Handle 16 and basket 3 are caused to vibrate or shake thus shaking off excess fat or oil from cooked food. A gearing ratio can be obtained by suitable selecting the sizes of driving gear 29 and cam wheel 17.

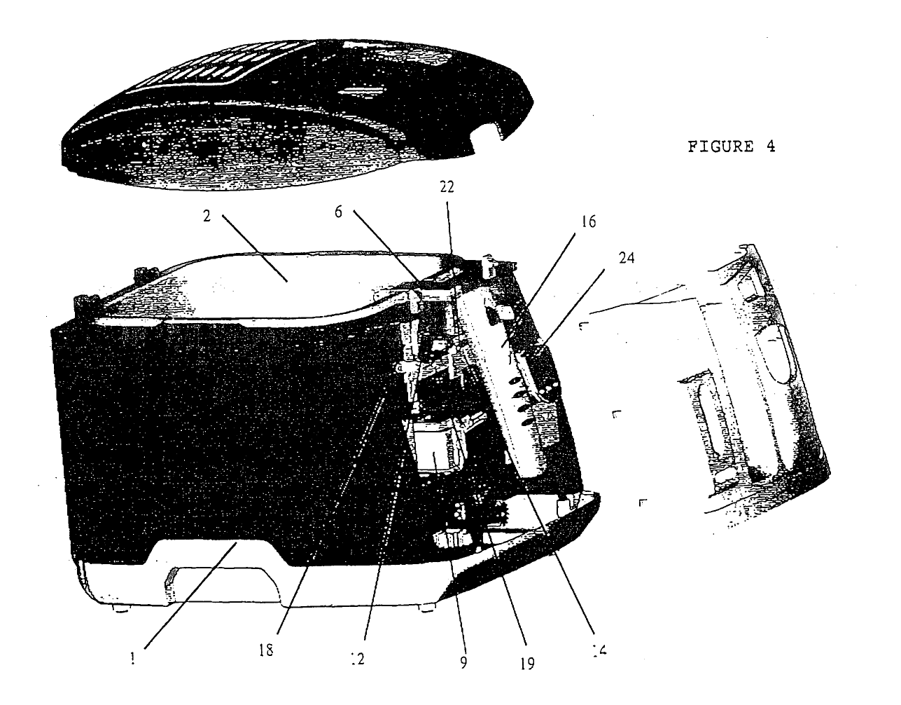

FIG. 4 shows the second embodiment of the invention with the handle 16 in the lower position wherein the food and basket 3 are immersed in cooking oil.

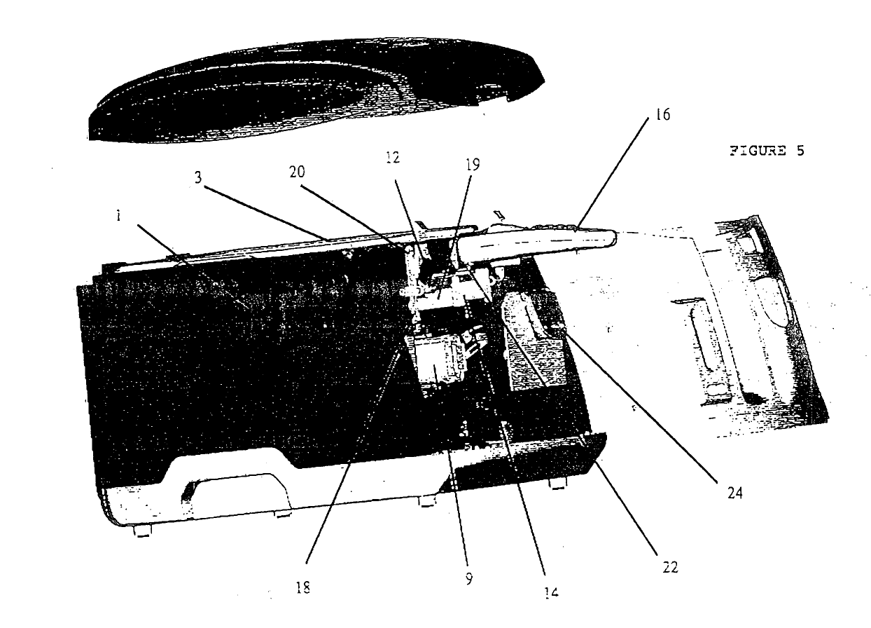

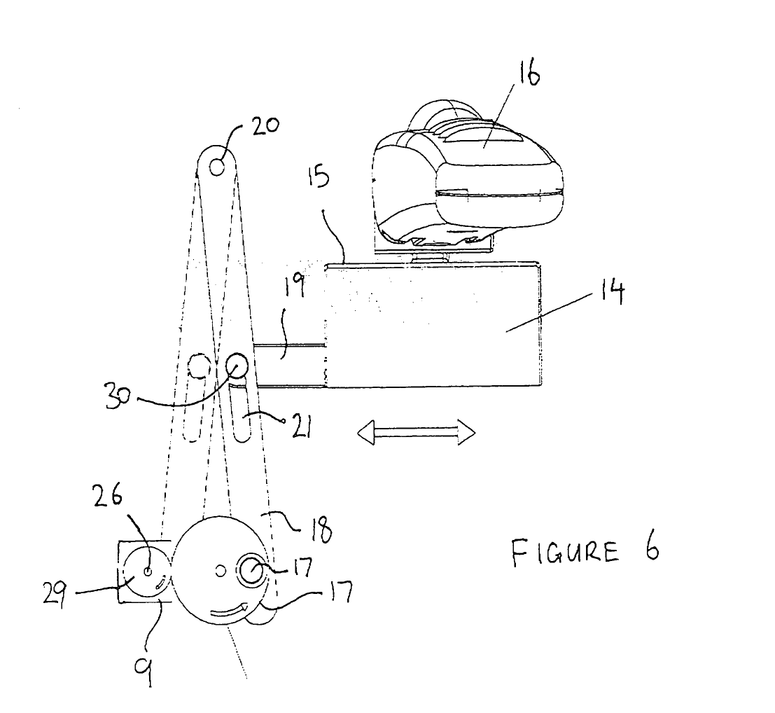

FIG. 5 shows the raised draining position with the food and basket emersed from the oil. When the handle 15 is raised, a resilient plate 22 is caused to activate micro-switch 11. The user can the operate a switch to activate the motor 9.

In an one embodiment of the invention the motor 9 is activated directly by micro-switch 12 when handle 7, or 16, is raised. After a predetermined time of between 30 or 60 seconds the motor is deactivated.

In further embodiments of the invention the predetermined time may be shorter or longer than 30 to 60 seconds depending on requirements. The predetermined time is pre-set, or means is provided to allow the user to pre-select the desired time within a set range. Such means may be a rotary dial for changing the preset time of the timer 23, or electronic means provided through an electronic controller 24 of the cooking device.

Where in the foregoing description reference has been made to integers or elements having known equuivalente then such are included as if individually set forth herein

Embodiments of the invention have been described, however it is understood that variations, improvements or modifications can take place without departure from the spirit of the invention or scope of the appended claims.

What is claimed is:

1. A food cooker comprising:
a chamber in which a cooking medium is heated;
a basket for supporting food to be cooked and movable between a first position in which the food is immersed in the cooking medium and a second position in which the food is emersed from the cooking medium, and
means for vibrating the basket for a predetermined length of time when it is in the second position.

2. A deep fryer, for use with a quantity of oil for cooking food, comprising:
a container for receiving and heating a quantity of oil,
a basket for holding food items and movable between a cooking position in which the food is immersed in the oil and a draining position in which the food is emersed from the oil, and
means for vibrating the basket in the draining position.

3. A deep fryer, for use with a quantity of oil for cooking food, comprising
a housing defining a chamber for receiving and heating a quantity of oil,
a basket for holding food items within the chamber, and movable between an immersed position and a emersed position,
a support for the basket and for selectively moving the basket between the immersed position and the emersed position, and
a vibrator for vibrating the support or basket in the emersed position.

4. The deep fryer of claim 3 in which the vibrator is a motor positioned with the support or basket and driving an offset unbalanced weight.

5. The deep fryer of claim 3 in which the support is slidably positioned with the housing, and the vibrator includes a motor for driving a cam, and a linkage between the cam and support for moving the support forward and backward.

6. The deep fryer of claim 3 further comprising a switch for activating the vibrator, and a timer for deactivating the vibrator after a predetermined length of time.

7. The deep fryer of claim 6 in which the switch activates the motor when the basket is moved to the emersed position

8. The deep fryer of claim 6 in which the predetermined length of time is 30 to 60 seconds.

9. The deep fryer of claim 3 in which the support includes a handle.

10. The food cooker of claim 1 wherein the means for vibrating the basket includes a vibrator and the food cooker further comprises a switch for activating the vibrator and a timer for deactivating the vibrator after a predetermined length of time.

11. The food cooker of claim 10 in which the switch activates the motor when the basket is moved to the emersed position

12. The food cooker of claim 10 in which the predetermined length of time is 30 to 60 seconds.

13. The deep fryer of claim 2 wherein the means for vibrating the basket includes a vibrator and the deep fryer further comprises a switch for activating the vibrator and a timer for deactivating the vibrator after a predetermined length of time.

14. The deep fryer of claim 13 in which the switch activates the motor when the basket is moved to the emersed position

15. The deep fryer of claim 13 in which the predetermined length of time is 30 to 60 seconds.
